(19) United States
(12) Patent Application Publication
(10) Pub. No.: US 2002/0032604 A1
(43) Pub. Date: Mar. 14, 2002

(54) Electronic coupon issuing system and issuing method

(76) Inventors: Hiroyuki Watanabe, Chiba-shi (JP); Hisashi Kitaura, Chiba-shi (JP); Takashi Kami, Chiba-shi (JP); Ryusuke Narukawa, Tokyo (JP); Hiroaki Goto, Kawasaki-shi (JP)

Correspondence Address: ADAMS & WILKS, 31st Floor, 50 Broadway, New York, NY, 10004, US

(21) Appl. No.: 09/864,959

(22) Filed: May 24, 2001

(30) Foreign Application Priority Data
May 25, 2000 (JP) 2000-154779

(51) Int. Cl. G06F 17/60

(52) U.S. Cl. 705/14

(57) ABSTRACT

An electronic coupon issuing system comprises an electronic coupon server having an electronic coupon generation approval registration section for registering information regarding approval of generation of a coupon, and an electronic coupon acquisition registration section for registering acquisition of the electronic coupon in association with ID information of an electronic coupon usage medium that is presented when the electronic coupon is used. An electronic coupon search section receives the ID information of the electronic coupon usage medium and searches for an electronic coupon that is useable in connection with the ID information, and an electronic coupon reception terminal receives the electronic coupon usage medium and verifies with the electronic coupon search section whether an electronic coupon exists while at the same time approving the use of useable coupons.

### BACKGROUND OF THE INVENTION

1. Field of the Invention

The present invention relates to a system and a method for issuing electronically realized imaginary coupons, or so-called e-coupons.

2. Description of the Related Art

Retail discount coupons have previously existed on the internet for every kind of restaurant, retail store and the like. With these coupons, information downloaded via the internet is printed out and taken to the pertinent store, with the result that the prices of food, drinks, etc. are discounted and various kinds of benefits are obtained.

However, even though the information has been obtained via the internet, the discount or other benefits cannot be obtained if one forgets to take the printed coupon to the pertinent store. There is also the problem that the process itself of printing out the coupon is bothersome.

Also, it is difficult to collect usage information about coupons which have been used in this manner, so this is ineffective with respect to the goal of absorbing marketing information from the usage of coupons.

### SUMMARY OF THE INVENTION

In light of these issues, the object of the present invention is to provide a system and a method for issuing an electronic coupon which omits the procedure of printing out the coupon, eliminates the bothersome aspect of having to take the printed coupon to the pertinent store, and can be used easily and conveniently.

In order to solve the above-mentioned problems, a first aspect of the present invention is an electronic coupon issuing system configured so as to enable a coupon reception counter to use an issued electronic coupon via any kind of coupon reception means, the electronic coupon issuing system characterized by comprising: an electronic coupon server having an electronic coupon generation approval registration means for registering information regarding approval of generation of the electronic coupon; an electronic coupon acquisition registration means for registering acquisition of the electronic coupon in association with ID information of an electronic coupon usage medium that is presented when the electronic coupon is used; and an electronic coupon search means for receiving the ID information of the electronic coupon usage medium and searching for an electronic coupon that is useable in connection with the ID information; and an electronic coupon reception terminal for receiving the electronic coupon usage medium, inquiring with the electronic coupon search means of the electronic coupon server whether an electronic coupon exists and at the same time approving the use of useable electronic coupons; wherein the electronic coupon acquisition registration means of the electronic coupon server receives a request for acquisition of an electronic coupon from an electronic coupon registration terminal and registers electronic coupon acquisition information in association with the ID information of the electronic coupon usage medium; and the electronic coupon search means receives the ID information of the electronic coupon medium and information regarding the usage objective which have been sent from the electronic coupon reception terminal; performs searches to determine whether or not an electronic coupon useable for the ID information and for the usage objective exists; and sends results from the search to the electronic coupon reception terminal.

In a second aspect of the present invention, according to a first aspect of the invention, is the electronic coupon issuing system further characterized in that the electronic coupon server has an electronic coupon usage information accumulation means for accumulating the search results from the searches performed by the electronic coupon search means and accumulating electronic coupon usage information.

In a third aspect of the present invention, according to the first aspect of the invention, is the electronic coupon issuing system further characterized in that the electronic coupon registration terminal is a mobile telephone or a computer which is connected to a network, or a digital broadcast reception terminal.

In a fourth aspect of the present invention, according to the first aspect of the invention, is the electronic coupon issuing system further characterized in that the electronic coupons used by the electronic coupon reception terminal are any of a variety of discount coupons, any of a variety of benefits, or any of a variety of tickets.

In a fifth aspect of the present invention, according to a first aspect of the invention, is the electronic coupon issuing system further characterized in that the electronic coupon reception terminal has a function of printing out and using the electronic coupon.

In a sixth aspect of the present invention, according to a fifth aspect of the invention, is the electronic coupon issuing system further characterized in that the electronic coupon reception terminal prints out the electronic coupon as a bar code and uses the bar code.

In a seventh aspect of the present invention, according to a first aspect of the invention, is the electronic coupon issuing system further characterized in that the electronic coupon usage medium is a credit card, a debit card, any of a variety of point-accumulation cards or any of a variety of mileage accumulation cards.

In an eighth aspect of the present invention, according to an seventh aspect of the invention, is the electronic coupon issuing system further characterized in that the electronic coupon usage medium is a credit card and the electronic coupon reception terminal serves also as a credit card settlement terminal, and this electronic coupon reception terminal is connected to the electronic coupon server via a credit settlement center or via a relay center relaying to a credit card settlement center.

In a ninth aspect of the present invention, according to an eighth aspect of the invention, is the electronic coupon issuing system further characterized in that the electronic coupon reception terminal simultaneously dispatches a search for the electronic coupon and a request for approval for a credit card settlement, and when the electronic coupon is useable for a discount, the electronic coupon reception terminal sends out a second request for a credit settlement at a discounted price.

In a tenth aspect of the present invention, according to an eighth aspect of the invention, is the electronic coupon issuing system further characterized in that the electronic coupon reception terminal and the credit card settlement center or relay center which relays to the credit card settlement center are connected wirelessly.

In an eleventh aspect of the present invention is an electronic coupon issuing method configured so as to enable a coupon reception counter to use an issued electronic coupon via any kind of coupon reception means, the electronic coupon issuing method being characterized by: registering approval information for generation of the electronic coupon; receiving a request for acquisition of the electronic coupon and registering electronic coupon acquisition information in association with ID information of the electronic coupon usage medium; and, upon reception of the electronic coupon usage medium, performing a search to determine whether there exists an electronic coupon that makes the electronic coupon usage medium usable, and approving the use of the electronic coupon usage medium in the case that a usable electronic coupon exists.

In a twelfth aspect of the present inventions according to an eleventh aspect of the invention, is the electronic coupon issuing method further characterized by accumulating electronic coupon usage information.

In a thirteenth aspect of the present invention, according to an eleventh aspect of the invention, is the electronic coupon issuing method further characterized by registration of the electronic coupons being performed by a mobile telephone or a computer connected to a network, or by a digital broadcast reception terminal.

In a fourteenth aspect of the present invention, according to an eleventh aspect of the invention, is the electronic coupon issuing method characterized in that the electronic coupon is any of a variety of discount coupons, benefits or tickets.

In a fifteenth aspect of the present invention, according to an eleventh aspect of the invention, is the electronic coupon issuing method further characterized in that the electronic coupon is printed out and used.

In a sixteenth aspect of the present invention, according to a fifteenth aspect of the invention, is the electronic coupon issuing method further characterized in that the electronic coupon is printed out and used as a bar code.

In a seventeenth aspect of the present invention, according to an eleventh aspect of the invention, is the electronic coupon issuing method further characterized in that the electronic coupon usage medium is a credit card, debit card, any of a variety of point accumulation cards or any of a variety of mileage accumulation cards.

In an eighteenth aspect of the present invention, according to a seventeenth aspect of the invention, is the electronic coupon issuing method further characterized in that the electronic coupon usage medium is a credit card and the credit card settlement terminal also serves to perform reception of the electronic coupon.

In a nineteenth aspect of the present invention, according to an eighteenth aspect of the invention, is the electronic coupon issuing method further characterized by performing the reception of the electronic coupons and the credit card settlement simultaneously, and performing the credit card settlement at a discounted price when an electronic coupon for a discount is usable.

According to the present invention, registered electronic coupons may be used simply by presenting an electronic coupon usage medium such as a credit card at the time of payment or at some other such moment, and eliminates the trouble of such as printing a coupon and taking it to the pertinent store. Also, there is an advantage in that information about acquisition and usage of such electronic coupons can easily be accumulated as a database, and is useful as information about the preferences of individuals, being extremely useful as a means for amassing marketing information.

### BRIEF DESCRIPTION OF THE DRAWINGS

In the accompanying drawings:

FIG. 1 is a diagram of an outline construction of an example of an electronic coupon issuing system in accordance with an embodiment of the present invention;

FIG. 2 is a diagram of an example of electronic coupon generation approval information in accordance with the embodiment of the present invention;

FIG. 3 is a diagram of an example of electronic coupon registration information in accordance with the embodiment of the present invention;

FIG. 4 is a diagram of an example search performed by an electronic coupon search means in accordance with the embodiment of the present invention and results produced by the search;

FIG. 5 is a diagram of another example search performed by an electronic coupon search means in accordance with the embodiment of the present invention and results produced by the search;

FIG. 6 is a diagram of an example of a usage report for an electronic coupon in accordance with the embodiment of the present invention;

FIG. 7 is a diagram of an outline construction of an example of a coupon issuing system in accordance with another embodiment of the present invention; and

FIG. 8 is a diagram of an outline construction of an example of a coupon issuing system in accordance with another embodiment of the present invention.

### DETAILED DESCRIPTION OF THE PREFERRED EMBODIMENTS

Hereinafter, explanation will be made regarding embodiments of the present invention.

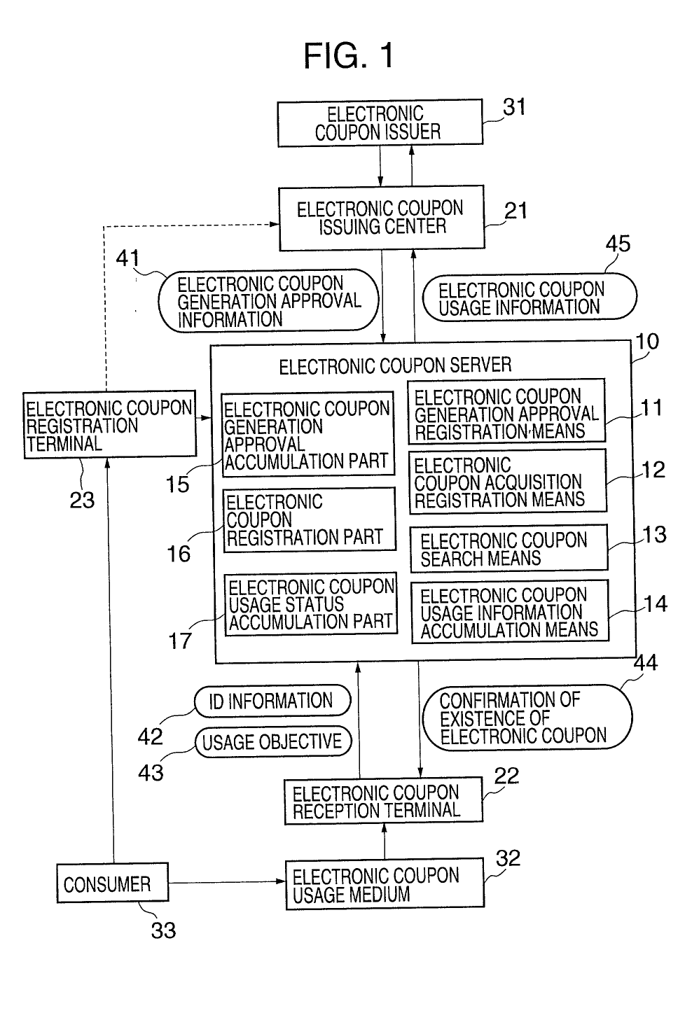

FIG. 1 shows a schematic structure of an electronic coupon issuing system according to an embodiment. As shown in this drawing, an electronic coupon server 10 has an electronic coupon generation approval registration means 11 for registering information regarding approval of generation of the electronic coupon; an electronic coupon acquisition registration means 12 for registering acquisition of the electronic coupon in association with ID information of an electronic coupon usage medium that is presented when the electronic coupon is used; an electronic coupon search means 13 for receiving the ID information of the electronic coupon usage medium and searching for an electronic coupon that is useable in connection with the ID information; and an electronic coupon usage information accumulation means 14 for accumulating search results from the search performed by the electronic coupon search means 13 and accumulating the use information of the electronic coupon. The electronic coupon server 10 is, connected to an electronic coupon issuing center 21 and various types of electronic coupon reception terminal 22, and receives coupon acquisition requests from a variety of types of electronic coupon registration terminal 23.

The electronic coupon server 10 is the core of the issuing system for electronic coupons such as imaginary discount certificates and tickets being electronically realized. The electric coupons are not just paper, but are registered as a form of information linked to an electronic coupon usage medium 32 such as a credit card.

Issuance of electronic coupons begins with a request to the electronic coupon issuing center 21 by an electronic coupon issuer 31 who wants to create publicity upon the issuing of the electronic coupon and wishes to amass market information.

The request from the electronic coupon issuer 31 includes information about what is to be used as the electronic coupon usage medium 32, what kind of electronic coupon is to be issued, for what objective and the like. Depending on the type of electronic coupon usage medium 32, there can be multiple electronic coupon issuing centers 21.

As an example, in the case that a credit card is used as the electronic coupon usage medium 32 for issuing a discount coupon for a particular merchandise, information such as a code indicating the type of the credit card, the kinds of merchandise to which the electronic coupon is applicable, the discount rate, the expiration date of the coupon is necessary.

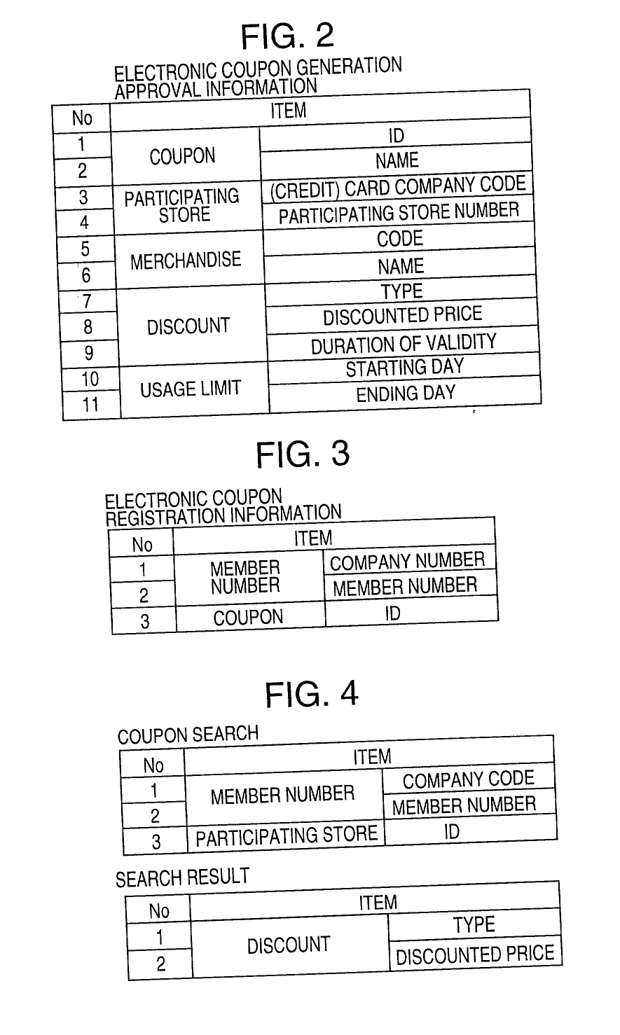

FIG. 2 shows an example of the electronic coupon generation approval information 41. In this case, electronic coupon generation approval information 41 includes the electronic coupon ID and name, participating stores so as to specify the locations where the electronic coupon can be used, information about the merchandise to which the electronic coupon is applicable, the discount information offered by the electronic coupon, the expiration date of the coupon, etc.

This sort of necessary information is sent as electronic coupon generation approval information 41 to the electronic coupon server 10 from the electronic coupon issuing center 21, and is registered in an electronic coupon generation approval accumulation portion 15 by an electronic coupon generation approval registration means 11.

The electronic coupon is generated by a consumer 33 using the electronic coupon registration terminal 23 and registering the electronic coupon.

Here, the electronic coupon registration terminal 23 is determined by an intention of the electronic coupon issuer 31. Using, for example, a computer connected to the internet, a BS digital broadcast receiver, an i-mode (brand name) or other portable telephone terminals, the consumer 33 makes his or her electronic coupon acquisition request via a particular method. In this case, when an electronic coupon is registered on a credit card, it is necessary to register ID information and other information pertinent to that credit card in advance or upon each occasion. Note, however, that it is possible to register an electronic coupon at the electronic coupon issuing center 21. It is also possible to register an electronic coupon by accessing the electronic coupon center 21 via the electronic coupon registration terminal 23.

The electronic coupon acquisition registration means 12 of an electronic coupon server 10 receives the electronic coupon acquisition request. Upon receiving the electronic coupon acquisition request, the electronic coupon acquisition registration means 12 searches the electronic coupon generation approval information accumulation part 15 and judges whether the electronic coupon can be registered or not. In the event that the electronic coupon can be registered, the electronic coupon acquisition registration means 12 creates a link with the ID information from the information pertaining to the credit card, and registers acquisition of the electronic coupon to an electronic coupon registration part 16. In other words, the following information is registered in such a way as to be associated with the ID information of the credit card: the name or identification code of the electronic coupon, the stores where the electronic coupon can be used, the time period during which the electronic coupon can be used and the content of the coupon, such as whether it is for merchandise or for food or for a discount, and the discount price or rate when the electronic coupon is for a discount. It goes without saying that such a database can be created, or only information that connects ID of the electronic coupon of the electronic coupon generation approval information accumulation portion 15 and ID of the electronic coupon usage medium 32 can be registered.

FIG. 3 shows an example of the electronic coupon registration information. In this case, for example, the code of a creditor company, the account number of a member, and a the coupon ID are accumulated.

In this way, the registered electronic coupon is used by the consumer 33 by presenting to an electronic coupon usage counter the credit card or other such electronic coupon usage medium 32 used to obtain the electronic coupon.

An electronic coupon reception terminal 22 is installed to the electronic coupon usage counter and is connected to the electronic coupon server 10 via the electronic coupon reception terminal 22. In this case, the electronic coupon reception terminal 22 reads the ID information stored on the electronic usage medium 32 and sends the ID information 42 and the usage objective 43 to the electronic coupon server 10. For example, when the electronic coupon usage medium 32 is a credit card, the electronic coupon reception terminal 22 serves as a credit card terminal as well. Note that, the usage objective 43 is information that has been registered at the electronic the coupon reception terminal 22 in advance, or is information that was inputted when the electronic coupon usage medium 32 was used. For example, the usage objective 43 could be information used to distinguish whether the electronic coupon is for merchandise, food or tickets, or can be lumped together and processed under a store code number.

The electronic coupon search means 13 in the electronic coupon server 10 performs the search for an electronic coupon registration part 16 based on the ID information 42 and usage objective 43 sent from the electronic coupon reception terminal 22, and determines whether there exists an electronic coupon that is usable in connection with the ID information 42 and the usage objective 43. That is, the electronic search means 13 performs a search to verify whether there is an electronic coupon that is associated with the ID information 42 and that matches with the usage objective 43. After the search is performed, a reply is sent to the electronic coupon reception terminal 22 as to whether such an electronic coupon exists or not.

In the event that such an electronic coupon does exist, the relevant discount or other such process is conducted at the electronic coupon counter based on the electronic coupon. Thus, the consumer 33 can use the electronic coupon.

FIG. 4 shows an example of a search and results thereof as performed by the electronic coupon search means 13. The coupon search is conducted based on the account number of the member (the account number being the ID of the electronic coupon usage medium 32) and the ID of the participating store so as to specify the usage objective. As a result, the discount electronic coupon is searched.

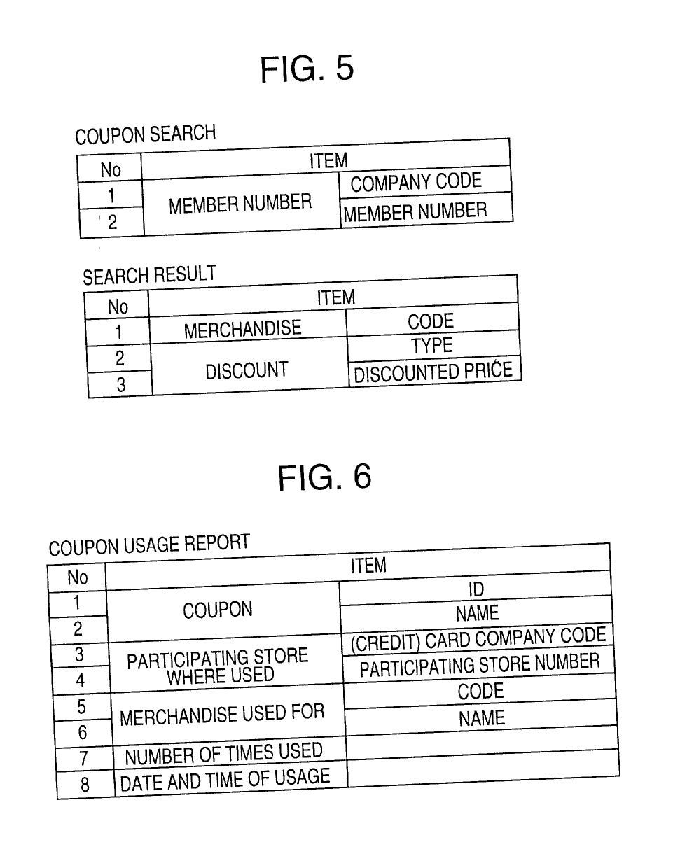

Of course, the search is not restricted to a particular method. For example, as shown in FIG. 5, it is possible to conduct a search based only on the account number of the member, which is the ID of the electronic coupon usage medium 32. The result of such a search is the retrieval of an electronic coupon offering a particular discount for a particular piece of merchandise.

In this example the ID of the participating store is used to indicate whether the electronic coupon can be used at that store or not. However, the unique terminal identification code assigned to the electronic coupon reception terminal 22 can also be used to indicated whether the electronic coupon can be used at that store or not.

Additionally, the electronic coupon usage information accumulation means 14 of the electronic coupon server 10 accumulates the search results produced by the electronic coupon search means 13 at the electronic coupon usage status accumulation part 17 on after another, and delivers the electronic coupon usage information 45 to the electronic coupon issuer 31 via the electronic coupon issuing center 21 at specified times as market information regarding a particular, electronic coupon.

FIG. 6 shows one example of a usage report for an electronic coupon. This report notes the type of electronic coupon, information about which participating store where the electronic coupon was used, the merchandise for which it was used, the date and time of use and other such information.

This type of electronic coupon issuing system enables the use of registered electronic coupons simply by presenting a credit card or other such electronic coupon usage medium 32 at the time of payment or at some other such moment, thus eliminating the procedure of the consumer 33 printing out the coupon and taking it to the pertinent store. Also, information about the acquisition and usage of such electronic coupons have the advantage of being easily accumulated as a database, and is useful as information about particular preferences of individuals for the electronic coupon issuer 31, being extremely useful as a means for collecting marketing information.

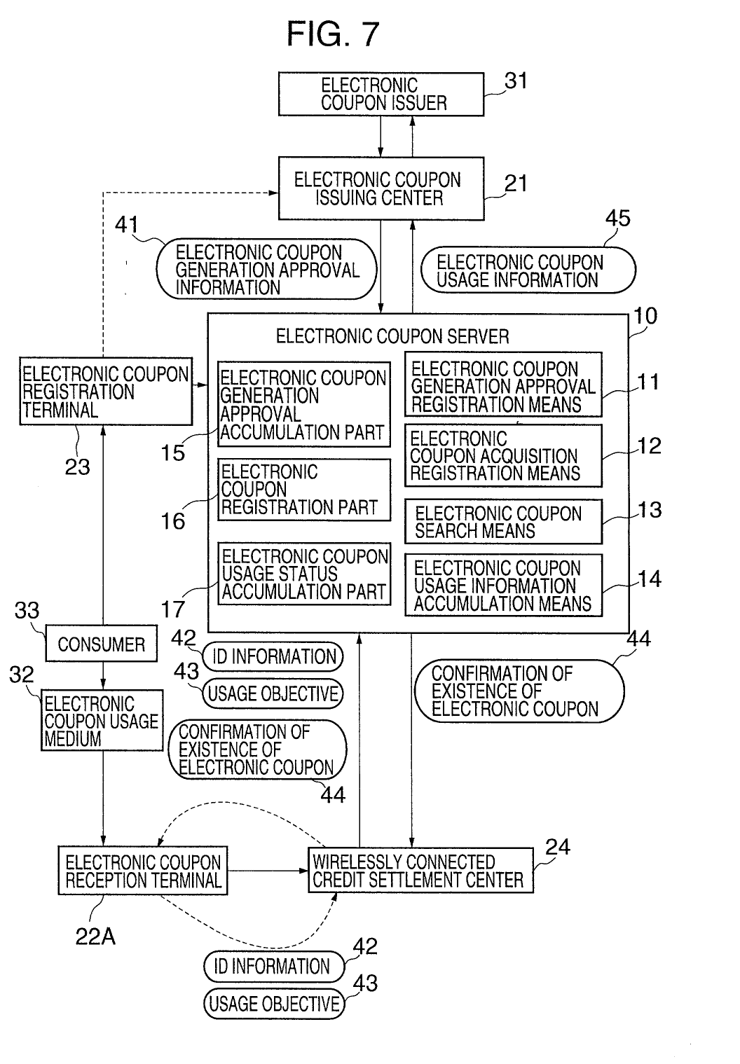

FIG. 7 shows an outline of a construction of the electronic coupon issuing system according to another embodiment. The same reference numerals have been used as in FIG. 1 to refer to the same parts, and explanations thereof have been omitted.

The electronic coupon issuing system shown in FIG. 7 is configured such that the electronic coupon usage medium 32 is a credit card, and the electronic coupon reception terminal 22A can be connected wirelessly via a credit card settlement center. In other words, the electronic coupon reception terminal 22A serves as a credit settlement terminal as well, and is connected to a credit settlement center 24 that receives credit settlements and electronic coupon searches wirelessly. The electronic coupon reception terminal 22A can access a database for credit settlement (not shown) via credit settlement center 24. In this case, the search for an electronic coupon and the confirmation of the credit settlement can be performed together or separately. Also, in the event that an electronic coupon for a discount exists, information about the electronic coupon can be returned to the electronic coupon reception terminal 22A and a second credit settlement can be performed based on the discount.

Here, the credit settlement center 24 is connected to each credit card company via NTT Data's network CAFIS (brand name). Therefore, information exchanges such as acknowledgment of credit card validity, credit limit, availability of settlement can be conducted.

Of course, it is possible to use a cord instead of a cordless connection to connect the electronic coupon reception terminal and the electronic coupon server via a credit settlement center.

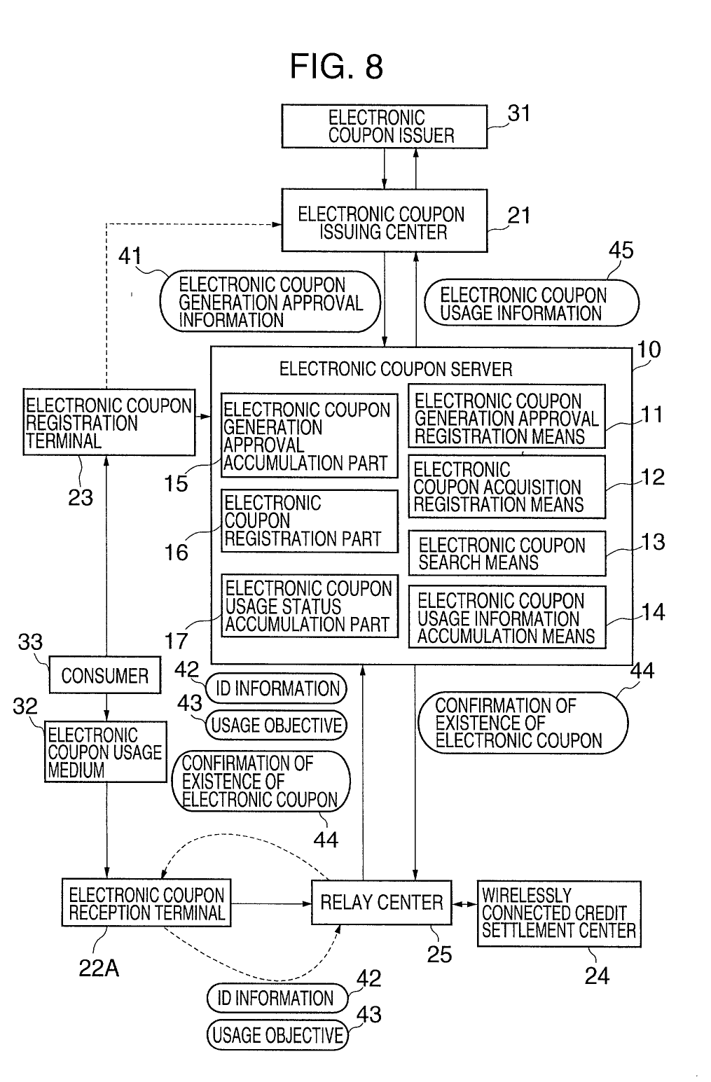

Also, as shown in FIG. 8, it is possible to connect the electronic coupon reception terminal 22A cordlessly to a relay center 25, and then via this relay center 25 connect to the electronic coupon server 10 and the credit settlement center 24. Of course, it is also possible to connect the electronic coupon reception terminal and the relay center by a cord.

Additionally, the electronic coupon described above does not necessarily need to be used as electronic information. For example, it is possible to print the coupon out as a bar code and use it. That is, in places such as supermarkets and convenience stores where complete point-of-sale systems are installed and it is difficult to use an electronic coupon registered on a credit card, the electronic coupon can be printed out as a bar code and used at a cash register as a discount coupon.

In this instance, the electronic usage medium is inserted, with the result that a search is conducted for an electronic coupon. An electronic coupon reception terminal may be arranged at the entrance of stores or at another such location for printing out a coupon certificate as a bar code corresponding to the electronic coupon in the event that a usable electronic coupon exists. Of course, printing is not limited to bar code printing, but can be normal printing as well.

Also, the electronic coupon is not only a discount coupon for merchandise at a store or for services, but can also be used as seat tickets or discount coupons for any kind of dramatic theatre, movie theatre, etc. In this case, the electronic coupon usage medium is presented at a window where the electronic coupon reception terminal has, been installed, with the result that the electronic coupon can be used just as is as electronic information, or may printed out and used.

As explained above, the present invention enables usage of a registered electronic coupon simply be presenting a credit card or other such electronic usage medium at the time of payment, with the result that the procedure of the consumer printing out the coupon and taking it to the pertinent store is eliminated. Also, there is the advantage that the usage status of the electronic coupon used in this way can be easily accumulated as a database. For an electronic coupon issuer, the electronic coupon usage status is useful as information about the particular preferences of individuals, and the electronic coupon usage status is extremely useful as a means for amassing marketing information.

What is claimed is:

1. An electronic coupon issuing system configured so as to enable a coupon reception counter to use an issued electronic coupon via any kind of coupon reception means, the electronic coupon issuing system characterized by comprising:
an electronic coupon server having an electronic coupon generation approval registration means for registering information regarding approval of generation of the electronic coupon; an electronic coupon acquisition registration means for registering acquisition of the electronic coupon in association with ID information of an electronic coupon usage medium that is presented when the electronic coupon is used; and an electronic coupon search means for receiving the ID information of the electronic coupon usage medium and searching for an electronic coupon that is useable in connection with the ID information; and
an electronic coupon reception terminal for receiving the electronic coupon usage medium, and inquiring with the electronic coupon search means of the electronic coupon server whether an electronic coupon exists and at the same time approving the use of useable electronic coupons;
wherein the electronic coupon acquisition registration means of the electronic coupon server receives a request for acquisition of an electronic coupon from an electronic coupon registration terminal and registers electronic coupon acquisition information association with the ID information of the electronic coupon usage medium; and
the electronic coupon search means receives the ID information of the electronic coupon medium and information regarding the intended use which have been sent from the electronic coupon reception terminal; performs searches to determine whether or not an electronic coupon useable for the ID information and for the intended use exists; and sends results from the search to the electronic coupon reception terminal.

2. An electronic coupon issuing system as claimed in claim 1, further characterized in that the electronic coupon server has an electronic coupon usage information accumulation means for accumulating the search results from the searches performed by the electronic coupon search means and accumulating electronic coupon usage information.

3. An electronic coupon issuing system as claimed in claim 1, further characterized in that the electronic coupon registration terminal is a mobile telephone or a computer which is connected to a network, or a digital broadcast reception terminal.

4. An electronic coupon issuing system as claimed in claim 1, further characterized in that the electronic coupons used by the electronic coupon reception terminal are any of a variety of discounts, any of a variety of benefits, or ant of a variety of tickets.

5. An electronic coupon issuing system as claimed in claim 1, further characterized in that the electronic coupon reception terminal has a function of printing out and using the electronic coupon.

6. An electronic coupon issuing system as claimed in claim 5, further characterized in that the electronic coupon reception terminal prints out the electronic coupon as a bar code and uses the bar code.

7. An electronic coupon issuing system as claimed in claim 1, further characterized in that the electronic coupon usage medium is a credit card, a debit card, any of a variety of point-accumulation cards or any of a variety of mileage accumulation cards.

8. An electronic coupon issuing system as claimed in claim 7, further characterized in that the electronic coupon usage medium is a credit card and the electronic coupon reception terminal serves as a credit settlement terminal, and this electronic coupon reception terminal is connected to the electronic coupon server via a credit settlement center or via a relay center relaying to a credit card settlement center.

9. An electronic coupon issuing system as claimed in claim 8, further characterized in that the electronic coupon reception terminal simultaneously dispatches a search for the electronic coupon and a request for approval for a credit card settlement, and when the electronic coupon is useable for a discount, the electronic coupon reception terminal sends out a second request for a credit settlement at a discounted price.

10. An electronic coupon issuing system as claimed in claim 8, further characterized in that the electronic coupon reception terminal and the credit card settlement center or relay center which relays to the credit card settlement center are connected wirelessly.

11. An electronic coupon issuing method configured so as to enable a coupon reception counter to use an issued electronic coupon via any kind of coupon reception means, the electronic coupon issuing method being characterized by: registering approval information for generation of the electronic coupon; receiving a request for acquisition of the electronic coupon and registering electronic coupon acquisition information in association with ID information of the electronic coupon usage medium; and, upon reception of the electronic coupon usage medium, performing a search to determine whether there exists an electronic coupon that makes the electronic coupon usage medium usable, and approving the use of the electronic coupon usage medium in the case that a usable electronic coupon exists.

12. An electronic coupon issuing method as claimed in claim 11, further characterized by accumulating electronic coupon usage information.

13. An electronic coupon issuing method as claimed in claim 11, further characterized by registration of the electronic coupons being performed by a mobile telephone or a computer which is connected to a network, or by a digital broadcast reception terminal.

14. An electronic coupon issuing method as claimed in claim 11, further characterized in that the electronic coupon is any of a variety of discounts, benefits or tickets.

15. An electronic coupon issuing method as claimed in claim 11, further characterized in that the electronic coupon is printed out and used.

16. An electronic coupon issuing method as claimed in claim 15, further characterized in that the electronic coupon is printed out and used as a bar code.

17. An electronic coupon issuing method as claimed in claim 11, further characterized in that the electronic coupon usage medium is a credit card, debit card, any of a variety of point accumulation cards or any of a variety of mileage accumulation cards.

18. An electronic coupon issuing method as claimed in claim 17, further characterized in that the electronic coupon usage medium is a credit card and the credit card settlement terminal serves to perform reception of the electronic coupon.

19. An electronic coupon issuing method as claimed in claim 18, further characterized by performing the reception of the electronic coupon and the credit card settlement simultaneously, and performing the credit card settlement at a discounted price when an electronic coupon for a discount is usable.
